(19) United States
(12) Patent Application Publication
(10) Pub. No.: US 2004/0180631 A1
(43) Pub. Date: Sep. 16, 2004

(54) Suspension system for portable telecommunications device

(76) Inventors: Kim Hock Lim, Singapore (SG); Chong Heng Choy, Singapore (SG); Steven John Cosgrove, Singapore (SG)

Correspondence Address: MOTOROLA INC, 600 NORTH US HIGHWAY 45, ROOM AS437, LIBERTYVILLE, IL, 60048-5343, US

(21) Appl. No.: 10/386,636

(22) Filed: Mar. 12, 2003

(51) Int. Cl. H04B 1/38

(52) U.S. Cl. 455/90.3; 455/569.1; 455/550.1

(57) ABSTRACT

A lanyard support for a portable telecommunications device (1) comprises an integrated headset and device suspension system with neck lanyard (5) havings a microphone (8), an earbud speakerphone (7) and a tensionable attachment member (10) securable to a lanyard bail (3) on the device (1). The portable telecommunications device (1) is located in a pouch (2) with extension cords (16,17) extending between the lower part of the pouch and a respective side of the neck lanyard. The portable telecommunications device (1) is suspended from the neck of a wearer to permit handsfree operation while an antenna (9) of the device (1) is inclined outwardly away form an upright axis of a wearer's torso to improve antenna sensitivity.

### FIELD OF THE INVENTION

The present invention is concerned with lanyard suspension systems for portable telecommunication devices, and particularly, although not exclusively, to a neck lanyard suspension system with an integrated headset for portable radiotelephones.

### BACKGROUND OF THE INVENTION

Small handheld electronic devices such as cellular telephones, personal digital assistants (PDA's), pagers, hand held computers and the like are becoming commonplace in society. With increasing use of such electronic devices there has been a demand for increased functionality and greater compactness for ease and convenience of use. Customarily these hand held electronic devices accompany users most of the time and as such, there is a need to avoid loss or inadvertent misplacement, as these devices are now so small and lightweight that their absence from a clothing pocket or a pocketbook is not readily noticed.

For convenience a lanyard or wrist strap can be secured to the body of a portable telecommunication device by means of a post protruding from the device body or a pin or lanyard bail located in a recess in the device body. U.S. Pat. No. 6,094,566 describes a lanyard bail movable between an extended and retracted position in a body of a radiotelephone.

Cellular telephones, pagers and the like often have a pouch or protective cover with a spring-biassed clip to secure the electronic device to a user's belt. U.S. Pat. No. 6,481,058 describes a portable apparatus with a housing having a retractable spring biassed belt clip or pocket clip.

Even with a belt or pocket clip, compact lightweight portable electronic devices can be stolen or inadvertently lost without the owner noticing the loss. U.S. Pat. No. 6,502,727 proposes a housing with a belt clip and a retractable cord tether extending between the housing and a small hand held device. A magnetic latch attached to the body of the hand held device enables it to be releasably secured to the housing.

Accompanying a need for improved portability of hand held telecommunication devices has been a requirement of users for easy and convenient use of these devices. Handsfree operation of mobile cellular radio telephones in motor vehicles has been facilitated by mounting kits having electrical couplings for a power source, external microphone and speaker and if required an external antenna coupling. U.S. Pat. No. 6,064,894 describes a portable radiotelephone which can be positioned against a user's ear during private operation or remotely for handsfree operation.

U.S. Pat. No. 5,590,417 describes a prior art handsfree system for a portable radiotelephone wherein a headset with a microphone and earphone provides for private operation.

U.S. Pat. No. 5,590,417 describes a wireless headset releasably attached to a mobile radiotelephone. The headset is attachable to a user's head by an ear clip to permit handsfree operation of the mobile radiotelephone. The headset includes a low power transmitter and receiver as well as an antenna for two-way communications over a short distance with the mobile radiotelephone which may be located in a user's pocket or pocketbook or clipped to a user's belt.

Yet another portable telecommunications device is described in U.S. Pat. No. 5,371,348. This device comprises a rather heavy, bulky data entry and collection unit supported by a harness worn around a user's neck. For ease of operation, a detachable display/scanner module is electronically coupled by a cord to the data entry/collection unit to facilitate use in a store for product identification, inventory checks or point of sale transactions. The device includes a radio communication assembly to transmit data and instructions to a remote data logging and control system. An external antenna associated with the data entry/collection unit facilitates radio communications with a remote transceiver or the like.

While the abovementioned portable telecommunications devices are generally satisfactory for their respective intended uses all are prone to reduced antenna sensitivity when worn or suspended close to a user's body. Accordingly there is a need for an improved method, system and/or device for supporting a portable telecommunications device for convenient and easy handsfree operation by a user without sacrificing antenna sensitivity.

### SUMMARY OF THE INVENTION

According to one aspect of the invention there is provided a method for enhancing antenna sensitivity during handsfree use of a portable telecommunications device suspended by a lanyard from a user's neck wherein said device is suspended with an antenna located in a plane inclined to an upright axis of a user's torso.

A free end of the antenna preferably inclines away from said upright axis of said user's torso.

The device may be suspendable from a user's neck with said antenna inclined at a predetermined angle relative to said upright axis of said user's torso.

Alternatively, the device may be suspendable from a user's neck with said antenna inclined at a selected angle relative to said upright axis of said user's torso.

Preferably said device is suspendable from a user's neck with an adjustable antenna inclination angle relative to said upright axis of said user's torso.

According to another aspect of the invention there is provided a suspension system for a portable telecommunications device, said suspension system having lanyard securable about a wearer's neck and attachable to said portable telecommunications device whereby in use, said system ensures handsfree suspension of said device from said wearer's neck with an antenna of said device located in a plane inclined outwardly at an angle relative to an upright axis of a wearer's torso.

The suspension system may include at least one upper attachment member securable adjacent an upper region of said device and at least one lower attachment member securable adjacent a lower region of said device.

The suspension system preferably includes a suspension mount to receivably locate said device therein, said suspension mount being attachable to a front portion of said lanyard.

It required, said suspension mount may comprise a support pouch securable over a lower region of device, said support pouch including said pair of lower attachment members.

Alternatively, said suspension mount may comprise a support frame having an upper attachment member securable to said device adjacent an upper end thereof and a lower attachment member at least partially surrounding a portion of a lower end of said device.

If required, said at least one upper attachment member may be releasably attached to a mounting member on an upper region of a body of said device.

The upper attachment member may be engageable with a lanyard bail adjacent an upper end of a body of said device.

Suitably, the upper attachment member comprises a housing with said adjustable loop extending from one end thereof, a free end of said loop extending from an aperture in said housing to tension said loop and a latch mechanism to secure said loop in a tensioned state.

If required, said upper attachment member may have a lock pin extending from one end of said housing body to releasably engage in a recess associated with a lanyard bail adjacent an upper end of said device.

If required, said system may include a headset for handsfree operation of said device, said headset including a microphone, an earphone and a plug for electrically coupling said headset to said device.

Preferably said headset is integrated with said lanyard.

If required, said device may be suspendable from a wearer's neck with said antenna inclined at a predetermined angle relative to said upright axis of said wearer's torso.

Preferably, said system is adapted to permit selective adjustment of an angle of inclination of said antenna relative to said upright axis of said wearer's torso.

The lanyard may be comprised of a rigid plastically deformable material.

Alternatively, the lanyard may be comprised of a flexible material.

The at least one lower attachment member preferably comprises a pair of lower attachment members spaced adjacent respective lower sides of said device.

Suitably, said pair of lower attachment members extend from said lanyard.

Suitably, at least part of said upper attachment member when engaged with said upper end of said device, rests against an upper portion of a wearer's torso.

If required, said lower attachment member may be pivotally connected to said upper attachment member.

According to a still further aspect of the invention there is provided a portable telecommunications device which enables handsfree operation by suspension from a neck of a wearer, said device including a suspension system ensuring, in use, location of an antenna of said device in a plane inclined outwardly to an upright axis of a wearer's torso.

The device may include at least one upper attachment member securable adjacent an upper region of said device and at least one lower attachment member securable adjacent a lower region of said device.

If required, the suspension system may include a suspension mount to receivably locate said device therein, said suspension mount being attachable to a front portion of said lanyard.

Suitably, said suspension mount comprises a support pouch securable over a lower region of said device.

Alternatively, said suspension mount comprises a support frame wherein said at least one upper attachment member is securable to said device adjacent an upper end thereof, and said at least one lower attachment member at least partially surrounds a lower end of said device.

Suitably, said at least one upper attachment member is releasably attachable to a mounting member on an upper region of a body of said device.

Preferably, said at least one upper attachment member comprises an adjustable loop engageable with a lanyard bail on an upper end of said body of said device.

Suitably, said at least one upper attachment member comprises a housing with said adjustable loop extending from one end thereof, a free end of said loop extending from an aperture in said housing to tension said loop and a latch mechanism to secure said loop in a tensioned state.

If required, said housing may include a lock pin extending therefrom to engage with a recess associated with said lanyard bail to resist rotation of said device in use.

The device may include a headset for handsfree operation of said device, said headset including a microphone, an earphone and a plug for electrically coupling said headset to said device.

Preferably, said headset is integrated with said lanyard.

If required, said upper attachment member may be pivotably attached to said lower attachment member.

### BRIEF DESCRIPTION OF THE DRAWINGS

FIG. 1 shows a radiotelephone device with an integrated headset/suspension system;

FIG. 2 shows schematically in profile the radiotelephone device and integrated headset/suspension system of FIG. 1 when supported on a wearer;

FIG. 3 shows an enlarged partial view of the connection between the integrated headset/suspension system and the radiotelephone of FIG. 1;

FIG. 4 shows a suspension system coupled to a radiotelephone;

FIG. 5 shows a suspension system with an integrated headset coupled to a radiotelephone;

FIG. 6 shows a radiotelephone with an alternative suspension system and integrated headset;

FIG. 7 shows another form of suspension system;

FIG. 8 shows a further form of suspension system;

FIG. 9 shows a still further form of suspension system; and

FIG. 10 shows yet another form of suspension system.

### DETAILED DESCRIPTION OF THE DRAWINGS

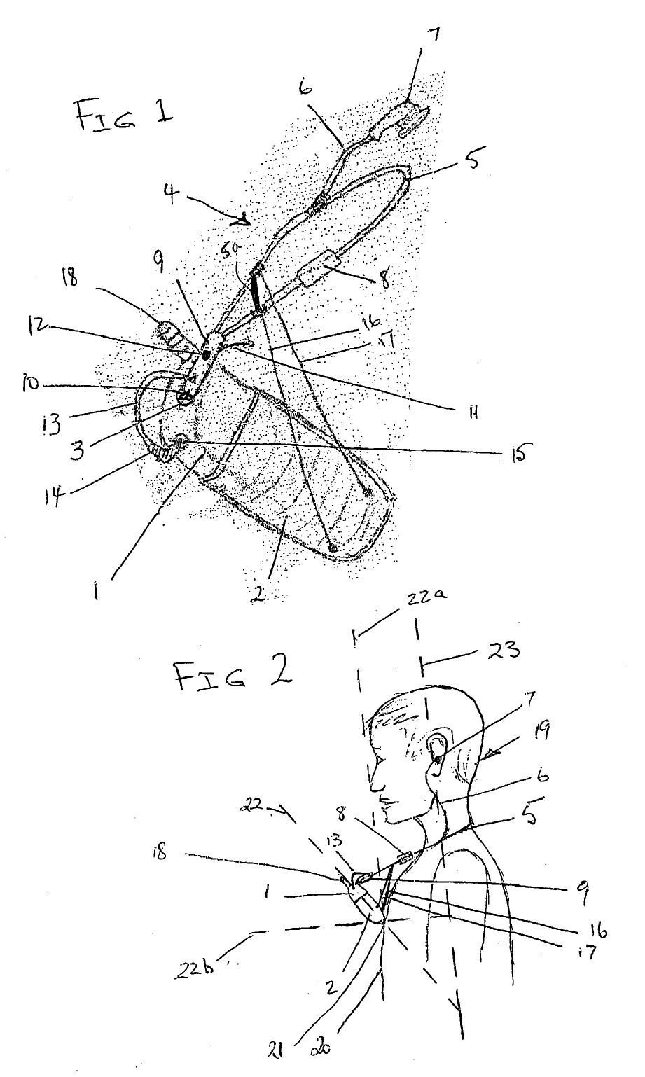

In FIG. 1 there is shown a radiotelephone 1 located within a flexible support pouch 2 fabricated from sheet plastics material or moulded from plastics material. Support pouch 2 is dimensioned to provide a snug fit for the radiotelephone therein and typically will include at least a transparent or open portion in the region of the operating buttons of the radiotelephone.

Secured to a lanyard bail 3 in the top of radiotelephone 1 is a headset 4 having a lanyard loop 5 which is able to be worn about a user's neck. Headset 4 includes a flexible cable extension 6 terminating with an earbud speakerphone 7 and a microphone 8. Headset 4 also includes an adjustable attachment device 9 securing the lanyard loop at one end and having an attachment loop 10 securable to lanyard bail 3. Attachment loop 10 is tensionable by means of a cord 11 releasably latched in the attachment device 9 by a latch button 12. Electrical coupling of the headset 4 to the radiotelephone 1 is facilitated by a flexible cable 13 extending from the attachment device 9 and terminating in an electrical plug 14 locatable in a mating socket 15 in radiotelephone 1. A pair of extension cords 16, 17 extend between lanyard loop 5 and respective lower sides of support pouch 2. Also, a rigid or semi rigid strut 5a, typically formed from a plastics material, extends across the lanyard loop 5. A stub antenna 18 extends from the top of radiotelephone 1.

FIG. 2 shows a profile view of the radiotelephone and headset/suspension system of FIG. 1 when supported on a wearer and for the sake of simplicity, like reference numerals are employed for like features in the drawings.

As shown, when lanyard loop 5 is supported about the neck of a wearer 19, radiotelephone 1 in the support pouch 2 is supported with the lower end of the pouch 2 in contact with a front portion of the wearer's torso 20, such as the sternum area 21, with the upper portion of the radiotelephone 1 spaced from the wearer's torso 20. In this manner, the antenna 18 of radiotelephone 1 is located in a plane 22 inclined at an angle to an upright axis 23 of the wearer's torso 20. Depending upon the length of extension cords 16,17, radiotelephone 1 may be supported against the wearer's torso 20 with antenna 18 located in a plane 22 inclined at an angle between an upright plane 22a substantially parallel to the upright axis 23 of the wearer's torso 20 through about 90° to a plane 22b inclined at an angle normal to the upright axis 23. Also, the strut 5a restricts twisting of the lanyard loop 5 that otherwise could allow for the antenna to be inclined at an angle towards the upright axis 23.

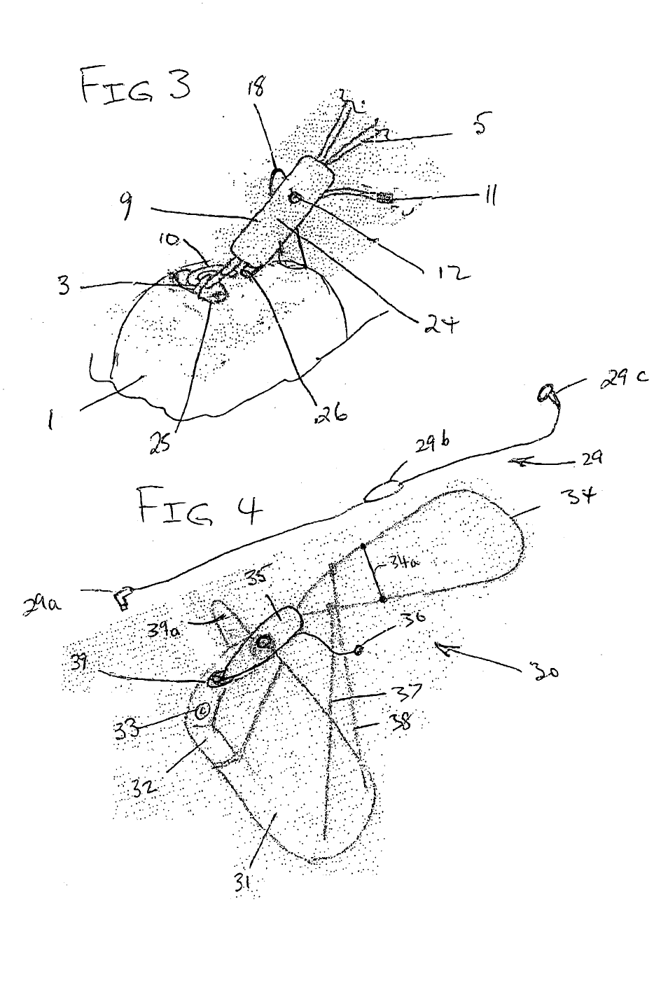

FIG. 3 is an enlarged partial view of the connection between the headset/suspension system of FIG. 1 and the radiotelephone 1. Again like reference numerals are employed for like features for the sake of simplicity.

In FIG. 3, attachment device 9 comprises a body 24 which secures the ends of the lanyard 5 and which body 23 supports an electrical cable 13 terminating in an electrical plug 14 insertable in mating socket 15 in radiotelephone 1. Extending from a lower part of body 24 is attachment loop 10 secured to lanyard bail 3 which spans a recess 25 in the upper part of radiotelephone 1. Also extending from a lower part of body 24 is a projecting lock pin 26 which engages in recess 25 when attachment loop 10 is tensioned by pulling on cord 11. When lock pin 26 is engaged in recess 25 with attachment loop 10 in a tensioned state, attachment device 9 projects rearwardly of radiotelephone 1 as shown in FIG. 2 to assist in maintaining the angle of inclination of the antenna plane 22 relative to the upright axis 23 of the wearers torso 20 and otherwise stabilizes the radiotelephone whilst suspended by resisting rotation thereof.

The latch button 12, when depressed, releases the tension in attachment loop 10 to facilitate detachment of the headset/suspension system shown in FIGS. 1 and 2.

FIG. 4 shows a radiotelephone suspension system 30 according to another aspect of the invention.

The suspension system 30 comprises a flexible or semi-rigid support pouch 31 in which is located a radiotelephone 32 with an upper portion of the radiotelephone 32 extending from pouch 31 to enable electrical coupling of a conventional headset via socket 33. Headset 29 includes an electrical plug 29a, a microphone 29b and an earphone 29c. A lanyard loop 34 is connected to an adjustable attachment device 35 of the type illustrated in FIGS. 1 and 3 of the drawings. Attachment device 35 is connected to radiotelephone 32 by an adjustable loop engaging over a lanyard bail as shown in FIG. 3 and like the attachment device of FIG. 3, device 35 includes a stub antenna 39a and a lock pin engageable in the recess 39 associated with the lanyard bail to resist rotation of the radiotelephone when suspended by lanyard 34 about the neck of a wearer. Again, like the attachment device 9 of FIGS. 1 and 3, a tensioning cord 36 permits attachment device 35 to be drawn into contact with radiotelephone 32 and a pair of extension cords 37, 38 extend from opposite sides of a lower part of pouch 31 to respective sides of lanyard loop 34. By suspending lanyard loop about a wearer's neck and electronically coupling a conventional headset to socket 33 in radiotelephone 32, a wearer can use the radiotelephone in a handsfree mode with antenna 39 ensured to be located in a plane inclined to an upright axis of the wearer's torso. Also, a rigid strut 34a on the lanyard loop, restricts twisting of the lanyard loop 34 when supported about the neck of the wearer 19.

FIG. 5 shows a modified form of the radiotelephone suspension system of FIG. 1 and for the sake of simplicity, like reference numerals are employed for like features.

In FIG. 5 the radiotelephone suspension system 40 comprises support pouch 2 with the pair of extension cords 16, 17 extending between lanyard loop 5 and pouch 2. Lanyard loop 5 comprises an integrated headset having a cable extension 6, an earbud speakerphone 7 and a microphone 8. An adjustable attachment device 9 includes tensionable attachment loop 10 which is tensionable by cord 11 and releasable by latch button 12. An electrical plug 13 is coupled to headset 4 via an electrical cable 14 in turn connected to attachment device 9. In this embodiment, attachment device 9 includes a pair of spaced lock pins 41,42 which engage in a recess in a radiotelephone body on opposite sides of a lanyard bail whereby when loop 10 is tensioned, attachment device 9 resists rotation of the radiotelephone when suspended from the neck of a wearer.

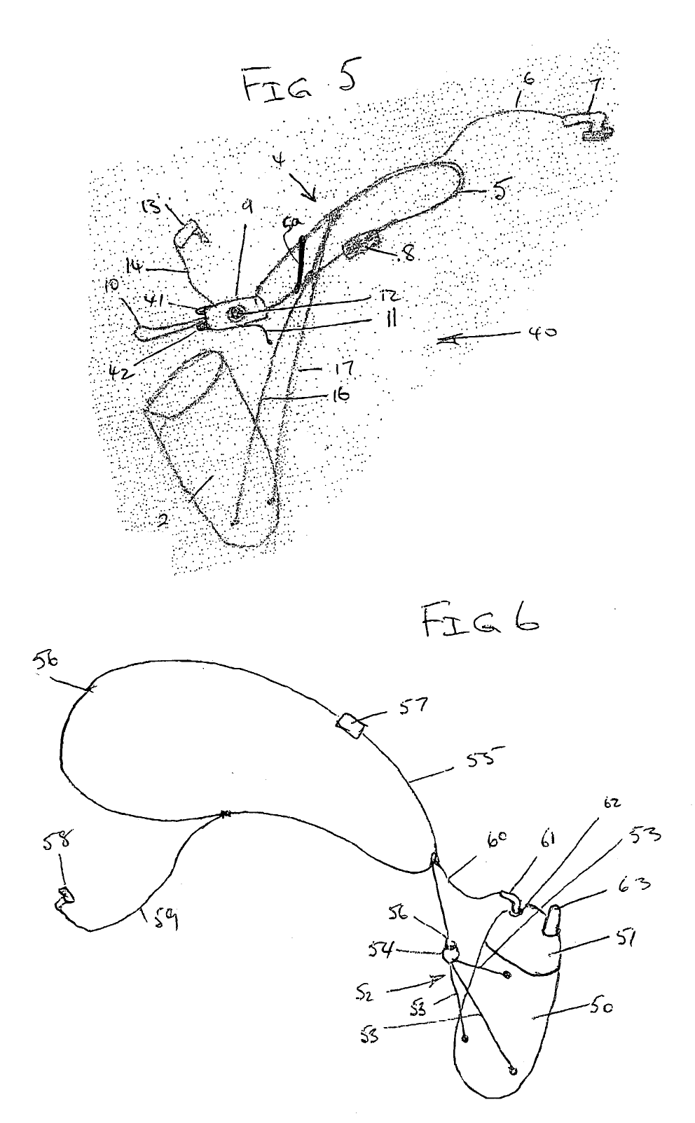

FIG. 6 shows a radiotelephone with an alternative suspension system.

In this embodiment, the suspension system comprises a moulded or fabricated pouch 50 of flexible plastics material to receivably locate a radiotelephone 51. A sling 52 comprised of flexible cords or chains 53 is secured to pouch 50 at either side of a lower end portion and at an upper central portion of pouch 50. Sling 52 includes an attachment ring or loop 54 to which a headset/lanyard combination 55 can be releasably secured by any known means such as a hook 56 or the like.

Headset/lanyard combination 55 is comprised of a plastically deformable neck lanyard 56 of a relatively stiff material such as a plastics coated metal wire which can be bent to comfortably accommodate the neck and upper torso contours of a wearer. Integrated with the neck lanyard 56 is a radiotelephone headset comprising a microphone 57, a speakerphone earbud 58 coupled to the assembly by a flexible electrical cable 59 and a further flexible electrical cable 60 terminating in an electrical plug 61 for electrically coupling the headset/lanyard combination 55 to a mating socket 62 on radiotelephone 51.

Like the headset/lanyard combination 4 shown in FIGS. 1 and 3, the headset/lanyard combination 55 of FIG. 5 reduces sensitivity losses in the antenna 63 during handsfree operation of the radiotelephone by suspending the radiotelephone 51 with the antenna 63 lying in a plane inclined to an upright axis of a wearer's torso, thereby spacing the antenna from the wearer's body.

FIGS. 7 to 10 show alternative embodiments of radiotelephone suspension amounts which may be employed with an integrated headset/lanyard combination of the type illustrated in FIGS. 1 and 3 or a neck lanyard with a separate conventional headset.

In FIG. 7, the suspension mount 70 comprises a flexible or rigid continuous band 71 adapted to engage about a lower portion of a radiotelephone body. Struts 72, 73, which may be integrally formed with band 71 or otherwise secured thereto, are coupled to an attachment ring or loop 74 to facilitate connection to an integrated headset/lanyard combination or alternatively to a neck lanyard for support form a wearer's neck. A stiff or rigid attachment member comprising strut 75 is pivotably connected at one end to ring or loop 74 and at its opposite end is formed a connection clip 76 adapted to engage about a lanyard bail of a radiotelephone to captively locate the radiotelephone in the suspension mount 70.

When suspended from the neck of a wearer by an integrated headset/lanyard combination or otherwise by a simple lanyard, the radiotelephone inclines forwardly at its upper end whereby the antenna of the radiotelephone is supported in a plane inclined at an angle to an upright axis of a wearer's torso.

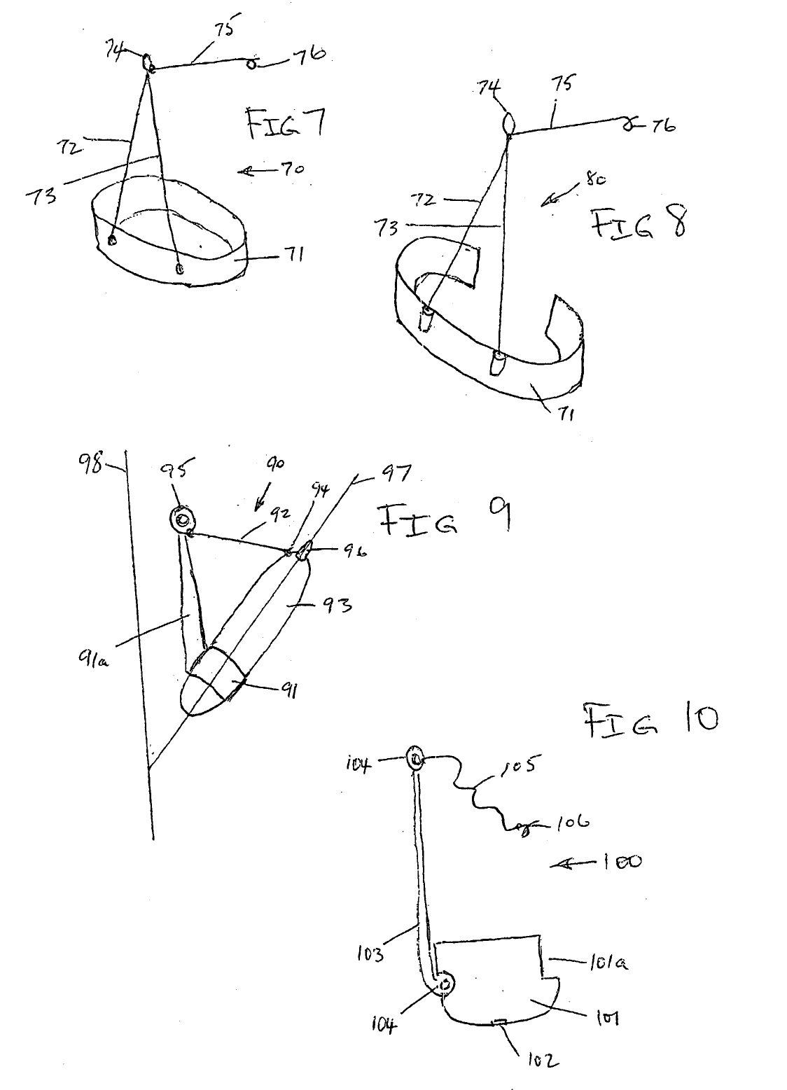

FIG. 8 shows a variation of the embodiment of FIG. 7 and for the sake of simplicity, like reference numerals are employed for like features.

In FIG. 8 a suspension mount 80 has a lower band portion 71 formed as a discontinuous band of a resiliently deformable plastics or metal material to enable resilient clamping of a lower body portion of a radiotelephone therein. Struts 72, 73 and 75 are rigidly coupled to attachment ring or loop 74 whereby when a radiotelephone is located in the lower band portion 71 with clip 76 engaged with a lanyard bail on the radiotelephone, each of struts 72, 73 and 75 resiliently bias the radiotelephone into engagement with lower band portion 71. Like the suspension mount 70 of FIG. 7, the suspension mount 80 of FIG. 8 is suspendable from an integrated headset/lanyard combination or a simple lanyard from a wearer's neck whereby the antenna of the radiotelephone is located in a plane inclined to an upright axis of a wearer's torso to avoid reduced antenna sensitivity.

FIG. 9 shows yet another variation of the embodiments of FIGS. 7 and 8.

The suspension mount 90 comprises an integrally formed lower band portion 91 and unitary support strut 91a. An attachment strut 92 is pivotably mounted to support strut 91a at one end and is releasably secured to a radiotelephone 93 at its other end by a clip 94 engageable with the lanyard bail of the radiotelephone. An attachment ring or loop 95 is releasably attachable to an integrated headset/lanyard combination or a simple neck lanyard worn about a wearer's neck to enable handsfree use of the radiotelephone with the antenna 96 located in a plane 97 inclined to an upright axis 98 of a wearer's torso.

FIG. 10 shows a still further embodiment of a suspension mount 100.

In this embodiment, the lower support member 101 is formed as a moulded cup like support having an aperture 102 in its base to enable securing of a radiotelephone therein by a screw threaded fastener or the like extending through aperture 102. A front portion 101a of lower support member 101 is removed to provide access to the lower portion of the keypad of a radiotelephone when secured therein. Extending from a rear portion of lower support member 101 is a support strut 103 pivotably attached to support member 101 by a pivotal coupling 104 movable between a retracted position and an extended position. At the upper end of support strut 103 is an attachment ring or loop 104 for releasable coupling with an integrated headset/lanyard combination or a simple neck lanyard. An attachment member comprising a flexible anchor cord 105 is secured at one end to suspension mount 100 and at its other end is a clip 106 for releasable connection to a lanyard bail of a radiotelephone.

A wearer may choose to support a radiotelephone in the suspension mount of FIG. 10 in a retracted position with the antenna of the radiotelephone lying in an upright plane, generally parallel to an upright axis of a wearer's torso. In a handsfree operational mode, the wearer is able to tilt the radiotelephone forwardly through any desired angle to a fully extended position dictated by the length of anchor cord 105. The angle range between retracted and extended positions may be from 0° to 90° representing the least and most optimised antenna sensitivity position. For the sake of comfort for a wearer, the extended position may be limited to an angle of between 30° and 60° where the plane in which the antenna of the radiotelephone lies during handsfree operation by a wearer.

The invention as exemplified by embodiments provides a simple yet elegant solution to the problem of reduced antenna sensitivity when a portable telecommunications device such as a cellular telephone is operated in a handsfree mode by a user. Hereunto whether the device was supported on a wearer's body by a belt or pocket clip or, more typically, in a wearer's pocket, antenna sensitivity was compromised by the close proximity between the antenna of the device and the body of a user of the device. By enabling a radiotelephone or similar portable telecommunications device to be carried by a user and supported during use in a handsfree mode with the antenna of the device ensured to be spaced from the user's body antenna, sensitivity losses can be substantially reduced. By integrating a headset into a lanyard the invention offers a convenient support system for handsfree operation of portable telecommunications devices whilst assisting in improving antenna sensitivity.

The detailed description provides a preferred exemplary embodiments only, and is not intended to limit the scope, applicability, or configuration of the invention. Rather, the detailed description of the preferred exemplary embodiments provides those skilled in the art with an enabling description for implementing a preferred exemplary embodiment of the invention. It should be understood that various changes may be made in the function and arrangement of elements without departing from the spirit and scope of the invention as set forth in the appended claims.

Throughout this specification and claims which follow, unless the context requires otherwise, the word comprise, and variations such as comprises or comprising will be understood to imply the inclusion of a stated integer or group of integers or steps but not the exclusion of any other integer or group of integers.

1. A suspension system for a portable telecommunications device, said suspension system having a lanyard securable about a wearer's neck to support said device whereby, in use, said system ensures handsfree suspension of said device from said wearer's neck with an antenna of said device located in a plane inclined outwardly at an angle relative to an upright axis of a wearer's torso.

2. A suspension system as claimed in claim 1 including at least one upper attachment member securable adjacent an upper region of said device and at least one lower attachment member securable adjacent a lower region of said device.

3. A suspension system as claimed in claim 1 including a suspension mount to receivably locate said device therein, said suspension mount being attachable adjacent a front portion of said lanyard.

4. A suspension system as claimed in claim 3 wherein said suspension mount comprises a support pouch securable over a lower region of said device.

5. A suspension system as claimed in claim 3 wherein said suspension mount comprises a support frame wherein said at least one upper attachment member is securable to said device adjacent an upper end thereof and said at least one lower attachment member at least partially surrounds a lower end of said device.

6. A suspension system as claimed in claim 2 wherein said at least one upper attachment member is releasably attachable to a mounting member on an upper region of a body of said device.

7. A suspension system as claimed in claim 6 wherein said at least one upper attachment member is engageable with a lanyard bail on an upper end of said body of said device.

8. A suspension system as claimed in claim 7 wherein said lat least one upper attachment member comprises a housing with said adjustable loop extending from one end thereof, a free end of said loop extending from an aperture in said housing to tension said loop and a latch mechanism to secure said loop in a tensioned state.

9. A suspension system as claimed in claim 8 wherein said housing includes a lock pin extending therefrom to engage in a recess associated with said lanyard bail to resist rotation of said device in use.

10. A suspension system as claimed in claim 1 including a headset for handsfree operation of said device, said headset including a microphone, an earphone and a plug for electrically coupling said headset to said device.

11. A suspension system as claimed in claim 10 wherein said headset is integrated with said lanyard.

12. A portable telecommunications device which enables handsfree operation by suspension from a neck of a wearer, said device including a suspension system ensuring, in use, location of an antenna of said device in a plane inclined outwardly to an upright axis of a wearer's torso.

13. A device as claimed in claim 12 including at least one upper attachment member securable adjacent an upper region of said device and at least one lower attachment member securable adjacent a lower region of said device.

14. A device as claimed in claim 12 including a suspension mount to receivably locate said device therein, said suspension mount being attachable to a front portion of said lanyard.

15. A device as claimed in claim 14 wherein said suspension mount comprises a support pouch securable over a lower region of said device.

16. A device as claimed in claim 14 wherein said suspension mount comprises a support frame wherein said at least one upper attachment member is securable to said device adjacent an upper end thereof and said at least one lower attachment member at least partially surrounds a lower end of said device.

17. A device as claimed in claim 12 wherein said at least one upper attachment member is releasably attachable to a mounting member on an upper region of a body of said device.

18. A device as claimed in claim 17 wherein said at least one upper attachment member is engageable with a lanyard bail on an upper end of said body of said device.

19. A device as claimed in claim 18 wherein said at least one upper attachment member comprises a housing with said adjustable loop extending from one end thereof, a free end of said loop extending from an aperture in said housing to tension said loop and a latch mechanism to secure said loop in a tensioned state.

20. A device as claimed in claim 19 wherein said housing includes a lock pin extending therefrom to engage with a recess associated with said lanyard bail to resist rotation of said device in use.

21. A device as claimed in claim 12 including a headset for handsfree operation of said device, said headset including a microphone, an earphone and a plug for electrically coupling said headset to said device.

22. A device as claimed in claim 21 wherein said headset is integrated with said lanyard.

23. A device as claimed in claim 13 wherein said upper attachment member is pivotably attached to said lower attachment member.
